(19) United States
(12) Patent Application Publication
(10) Pub. No.: US 2008/0191138 A1
(43) Pub. Date: Aug. 14, 2008

(54) High-energy radiation scintillation detector comprising multiple semiconductor slabs

(76) Inventors: Alexander Kastalsky, Wayside, NJ (US); Serge Luryi, Old Field, NY (US)

Correspondence Address: Alexander Kastalsky, 3 Kenneth Dr, Wayside, NJ, 07712, US

(21) Appl. No.: 11/703,805

(22) Filed: Feb. 8, 2007

(51) Int. Cl. G01T 1/20

(52) U.S. Cl. 250/361 R

(57) ABSTRACT

A multilayer semiconductor scintillator is disclosed for detection, energy quantification, and determination to source of high-energy radiation, such as gamma or X-ray photons or other particles that produce ionizing interaction in semiconductors. The basic embodiment of the inventive detector comprises a multiplicity of stacked direct-gap compound semiconductor wafers, such as InP and GaAs, each wafer heavily doped n-type so as to maximize its transparency to scintillating radiation. Each wafer is further endowed with surface means for detection of said scintillating radiation, such a hetero-epitaxial p-i-n photodiode. In a preferred embodiment, the photodiode layer in each wafer is pixellated so as to provide the x and y coordinates of an ionizing interaction event. Combined with the z coordinate provided by the wafer index in the stack, the inventive detector yields the three-dimensional coordinates of each ionizing interaction event associated with absorption of an individual quantum of high-energy radiation. This three-dimensional information enables a further disclosed advantageous analysis method that is suitable for rapid identification of radioactive isotopes and determination of the direction to the source of radiation.

### FIELD OF THE INVENTION

The invention relates to solid-state high energy radiation detectors, more specifically to scintillating detectors made of direct-gap semiconductors.

### Introduction

This patent application builds upon an earlier U.S. patent application Ser. No. 11/144,443, filed Jun. 6, 2005 and titled “Semiconductor scintillation high-energy radiation detector”. In that application, a semiconductor scintillator detector is disclosed in which ionizing radiation creates electron-hole pairs that subsequently undergo interband recombination, producing infrared light to be registered by a photo-detector. To make the semiconductor essentially transparent to its own interband radiation, a direct gap semiconductor, such as InP or GaAs, is heavily doped with shallow donors to produce the blue shift of the absorption edge, an effect known as the Burstein shift. Owing to the high Fermi level E_{F} for electrons, in such materials the absorption edge is shifted to shorter wavelengths, compared to the interband emission spectrum. The absorption of interband radiation is suppressed by the absence of vacant electronic states under the Fermi level and the suppression factor depends exponentially on the E_{F}/kT ratio.

The heavy doping makes the semiconductor more transparent to the scintillation photons and enable to extract said photons from deep inside the semiconductor. Limitations on the absorption length are discussed further below. In addition, the heavy doping shortens the radiative recombination time τ of holes, according to τ=1/BN_{D}, where N_{D} is the donor concentration and B=10⁻¹⁰ cm³/s is the radiative recombination coefficient. For the doping level of 10¹⁹ cm⁻³ in InP one has τ˜10⁻⁹ s. Typically, the non-radiative time is about 10⁻⁷ s. Therefore, the device experiences little loss through the non-radiative channel of recombination and provides a fast response time of 1 ns.

The calculated absorption length λ in InP at the optical wavelength of 0.92 μm, typical for the InP interband emission spectrum is shown in FIG. 1 as a function of doping concentration N_{D} for different temperatures. For N_{D}=10¹⁹ cm⁻³ at room temperature, the absorption length, as limited by the blue-shifted interband absorption, is λ≈3 mm. The presented exponential temperature dependence shows a potential for performance improvement at lower temperatures, where the same values of the absorption length can be accomplished with reduced donor density.

FIG. 1 also shows the free-carrier contribution to absorption, obtained from the data of W. P. Dumke, M. R. Lorenz, and G. D. Pettit, “Intra- and Interband Free-carrier Absorption and the Fundamental Absorption Edge in n-Type InP”, Phys. Rev. B 1, pp. 4668-4673 (1970). It is seen from these data that for N_{D}=10¹⁹ cm⁻³ the free-carrier absorption provides a more stringent limitation of the absorption length than the interband absorption. Further increase of the electron density, desirable for the increase of the E_{F}/kT ratio, becomes impractical due to the rise of the free-carrier absorption. Therefore, the free-carrier absorption becomes the main mechanism, limiting the device thickness at room temperatures to about ˜0.5-1 mm at the optimum donor density of 6-8×10¹⁸ cm⁻³. This thickness limitation poses a serious problem in the application to high-energy gamma radiation, where much larger device thickness is required.

One of the main objectives of the present invention is to lift said thickness limitation by integrating multiple semiconductor slabs into a single block, each of said slabs provided with its own epitaxial photo-detector for the registration of scintillator signal, while the slab thickness is kept in the range of about 0.5 mm, to minimize the light absorption and thus maximize the light delivery to the photo-detector.

Another objective of the present invention is to disclose a new method of registration of the radiation events using registration of the radiation penetration into the depth of the detector which provides a new method of analysis of the radiation energy.

Still another main objective of the present invention is to disclose new analysis methods that become available with 2-dimensional (2D) pixellation of the photo-detector layer in each slab, thereby producing a possibility of a 3-dimensional (3D) pixellation of registered ionization events.

Finally, still another main objective of the present invention is to disclose an analysis methodology of the inventive radiation detector that enables interpreting the measured 3D-pixellated data for the determination of both the radiation energy and direction to the radiation source.

### SUMMARY OF THE INVENTION

To circumvent the problem of thickness limitation, arising from the finite absorption length for the scintillator light in the semiconductor slab, a new design is disclosed, according to the present invention, wherein the detector represents a multiple stack of relatively thin semiconductor slabs, each slab being thinner than the scintillator light absorption length. Each slab is further endowed with an epitaxially grown photo-detector that has high absorption coefficient for scintillator light and a sufficient thickness to fully absorb said scintillator light. The stack of such slabs according to the present invention can accommodate a long absorption length of the high-energy gamma radiation without any loss in either the scintillator yield or the speed of response. In the preferred embodiment, the epitaxial photodetector is implemented as a p-i-n junction made of direct-gap semiconductor material with the absorption coefficient of about 10⁴ cm⁻¹ and of sufficient thickness that the light-to-current conversion efficiency approaches 100%. This provides an advantage over photo-multipliers used in conventional scintillators, where said efficiency is typically only 25%, as discussed in the well-known textbook by G. F. Knoll, “Radiation detection and measurement”, 3^{rd} edition, Wiley, N.Y. (2000). Another advantage of the inventive gamma-radiation scintillator over the photo-multiplier based scintillators is owing to its achievable miniature dimensions, where the total volume can be as low as ˜1 cm⁻³.

The epitaxially grown photodetector material is chosen to possess a substantially the same refractive index as the bulk material of the slab, thus minimizing the optical losses from internal light reflection at the epitaxial interface between the slab and the photodetector. This feature serves to maximize the collection of scintillator light.

For InP-based detector slab, the preferred lattice-matched material is the quaternary compound InGaAsP, which can be employed to grow the photo-detector structure with an energy gap varied widely between 1.35 eV and 0.8 eV. For GaAs, the preferred epitaxial material for the photo-detector is a dilute-nitride InGaAs/N stress-compensated structure that allows growth of a photo-sensitive layer with the energy gap below that of GaAs.

In the preferred embodiment, the epitaxial photo-diode is implemented as a p-i-n junction. As is well known to those skilled in the art, the photosensitive intrinsic “i” layer must be fully depleted. In the inventive design the total thickness of the photo-sensitive layer to be depleted is only ˜2 μm, which can be easily depleted even when the background dopant density level is relatively high. For example, for background donor concentration of 10¹⁵ cm⁻³, one needs only about 3V of reverse biasing for full depletion.

The simplest, non-pixellated detector embodiment, according to the present invention, comprises a stack of semiconductor slabs with a parallel connection of all epitaxial p-i-n junctions in the stack. This results in an integrated radiation detector response from its full volume. This electrical response is then amplified by a single amplifier circuit, located outside of the radiation detector. It is preferable to use Si technology for electronic signal processing and attach a Si chip. This chip may include an analog-to-digital conversion circuitry that delivers amplified digital information to the recording device or a computer.

Another preferred embodiment employs one amplifier per each slab. The amplified signal from each slab is converted to a digital form and then delivered it to the signal analyzing system. One advantage of this embodiment is that the signal to be delivered is no longer a one-nanosecond analog pulse, but rather a train of standard digital pulses encoding the available information. The information available includes the index of the active slab, i.e. that slab where the signal has fired and the time when the signal occurred. The index information relates to the z-coordinate of the ionization characterization, where the z-axis is along the direction of slab stacking. This design enables tracing of the one-dimensional signal dependence on the depth within the stack. The resultant one-dimensional signal profile can be analyzed to provide an additional characterization of the energy of ionizing radiation according to its penetration depth dependence.

Still another preferred embodiment employs a two-dimensional photo-detector array on the surface of each slab in the stack. This provides a 2D pixellation that enables recording the registration of xy coordinates of an ionization event in each slab. The entire stack of detector slabs can then be viewed as a three-dimensional integration of 2D-pixellated detector arrays. This provides a 3D pixellation of the ionization events.

The contemplated typical thickness of the single scintillator slab is in the range between 0.25 and 2.5 mm, as dictated by the absorption length data, such as in FIG. 1, and the penetration length of gamma photons of interest. From the practical standpoint, we consider it advantageous to employ commercially available standard InP or GaAs wafers of thickness 0.35-0.5 mm, with photo-sensitive layers grown on one or both of the wafer planar surfaces. The number of wafers stacked is unlimited and in practice will be determined by the considerations of cost relative to the performance for a particular gamma- or X-ray energy of interest. The detector lateral size is determined by the wafer diameter.

The lateral pixellation of the photosensitive layer in each slab can be arranged in a number of ways, known to those skilled in the art of photo-diode matrices. In the preferred embodiment, the lateral pixellation is accomplished by providing a set of horizontal and vertical stripes of contact layers of n⁺ and p⁺ polarity, thereby forming a pixel matrix wherein every pixel is determined by the intersection of one vertical and one horizontal line connected to the pixel p-i-n junction. All horizontal lines and all vertical lines in every slab are connected to their respective common electrodes in order to enable the application of a reverse-biased voltage to the entire pixel array. To provide pixel addressing with electronic amplification of the signals, a row and a column of amplifiers are introduced in such a way that every pixel is uniquely identified by the action of two amplifiers. Such a pixellated matrix architecture allows collection of the 3D information per each ionization event.

The information obtained in 3D-pixellated detector structure enables the implementation of novel analysis techniques, based on the kinematics of the interaction of gamma radiation with the pixel material. Interacting incident gamma quanta experience a series of Compton scattering events and ultimately, when the gamma energy becomes sufficiently low, a photoelectric absorption. Each interaction event results in a partial transfer of the gamma quantum energy to form electron and hole pairs in a particular pixel. These e-h pairs recombine to produce the scintillating photons that in the inventive device are registered pixel-wise. Typically, one expects 3 to 6 pixels to simultaneously become active upon the absorption of a single gamma quantum of exemplary energy 0.662 MeV. The measured information includes the 3D position coordinates (x, y, and z) of the active pixels and the total number (N) of scintillating photons produced in each active pixel. The number N serves as a measure of the energy deposited in said pixel.

### BRIEF DESCRIPTION OF THE DRAWINGS

FIG. 1 shows the dependence of the absorption length λ on the electron concentration and temperature in n-type doped InP. Both the interband and the free-carrier contributions to absorption are shown.

FIG. 2 schematically shows the side view of the non-pixellated radiation detector with parallel connection of photo-detectors (a) and the energy band diagram of the photo-detector layers (b).

FIG. 3 shows the side view of the non-pixellated radiation detector with signal registration and signal processing in each sub-detector.

FIG. 4 shows the top view (a) and the side-view (b) of the 3D pixellated radiation detector.

FIG. 5 shows schematically the circuit architecture of a 2D pixellated wafer that minimizes the number of amplifiers required. FIG. 5a shows an exemplary 3×3 pixellated structure and FIG. 5b illustrates the electrical circuit associated with the firing pixel.

FIG. 6 illustrates a cluster of first four Compton interactions arising from a single gamma quantum incident on the 3D pixellated detector. Each pixel reports the deposited energy, its own x, y, and z coordinates and in a preferred embodiment the time of the event. The reported parameters are analyzed to determine the incident energy of the gamma quantum and, after more than one gamma quantum is recorded, the direction to the source.

FIG. 7 illustrates another preferred method of analysis that determines the direction to a point source of gamma particles.

### DETAILED DESCRIPTION OF THE INVENTION

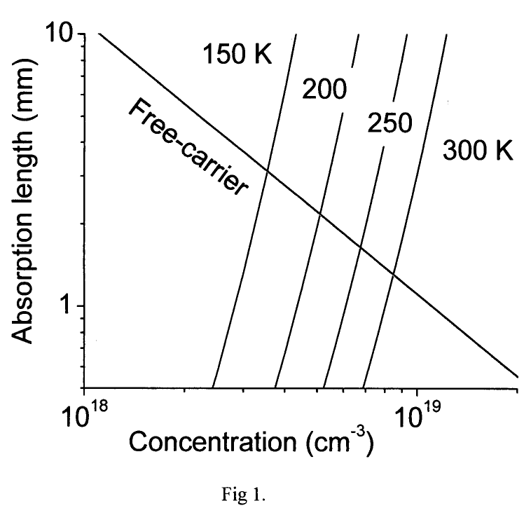

FIG. 1 shows the dependence of the absorption length λ on the electron concentration and temperature in n-type doped InP at the optical wavelength of 0.92 μm, typical for the InP interband emission spectrum. Both the interband and the free-carrier contributions to absorption are shown. The interband curves are labeled with the values of temperature T in degrees K. The free-carrier curve is approximately independent of temperature. Similar graphs, constructed for other than InP compound-semiconductor materials, like GaAs or CdTe, will serve to determine the maximum thickness L of semiconductor slabs according to the invention. In the preferred embodiment, one must have L<λ.

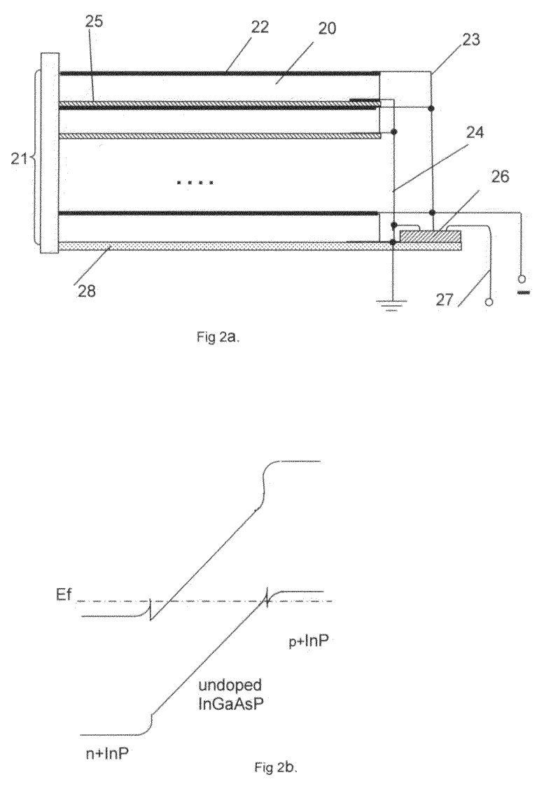

FIG. 2 schematically illustrates one of the embodiments of the non-pixellated radiation detector, according to the present invention. In FIG. 2a, a cross-sectional view of the device structure is presented. Multiple semiconductor slabs 20, are integrated into one block 21. The slabs 20 are isolated from each other with a dielectric film 25, while all p-i-n junctions are connected in parallel with leads 23 and 24, to apply a reverse biased voltage (minus on p+ contact) and thus deplete all the p-i-n junctions. In this configuration, the device operates as a thick scintillator with built-in light registration elements in each sub-detector, wherein no spatial information on ionizing events is available. Those skilled in the art will readily appreciate that instead of the dielectric film 25 a vacuum or gas-filled, exemplarily air-filled, spacing can be used, supported by a set of dielectric columns or spherical balls.

The detector output lines 23 and 24 enter a Si electronic chip 26 to amplify the integrated signal and convert it into the digital form prior to delivering it through the line 27 to recording, analyzing and storing system outside the integrated block. The chip is attached to the substrate 28 (glass) which supports the entire device.

As discussed above, the chosen semiconductor material is optically direct to provide high efficiency of scintillating light radiation. It is also heavily doped to minimize the light losses in the slab, as well as to reduce the non-radiative component of the electron-hole recombination and decrease the emission response time. Two best candidates for the slab materials are n+ InP and n+ GaAs, since they are the most technologically advanced and mass produced for the optoelectronic industry.

The preferred detector embodiment uses standard InP or GaAs wafers as semiconductor slabs. Besides their lower cost, such an approach allows one to choose the wafer thickness below the penetration depth of ionizing radiation, while the combined thickness of all wafers in the integrated block can be made thicker than the absorption length of the ionizing radiation. For example, 0.3 mm-thick wafers of InP or GaAs are commercially available and are thinner than the characteristic absorption length for the γ-radiation energy above ˜80 KeV, see the above cited textbook by G. F. Knoll. Photons of lower energy, X-rays, will be stopped primarily in the first layer.

The top area of each slab in FIG. 2a comprises the photo-diode structure 22 deposited on the wafer surface. The exemplary energy-band diagram of the photo-diode is shown in FIG. 2b. To minimize the signal losses, it is preferable to epitaxially grow a lattice-matched heterostructure that has practically the same index of refraction as the underlying slab. This largely eliminates the adverse effect of light internal reflection. It is important to note that the energy gap of the heavily doped slab material is typically lower than that of the same material when it is undoped. At the electron density of ˜1019 cm⁻³, the energy gap of InP shrinks by about ˜70 meV. It is critical that the detector heterostructure material be chosen so as to adapt to this energy-gap shrinkage. In the preferred embodiment, the bandgap of the detector material is chosen to be at least as low or lower than the shrunken bandgap of the doped slab material. At the same time, to maintain the crystalline quality, the epitaxial detector material must be lattice-matched to the bulk material of the slab. For InP, the most appropriate material is quaternary InGaAsP compound, as shown in FIG. 2a, which can provide the needed energy gap of 1.28 eV. For GaAs, we contemplate using the so called “dilute nitride”, stress-compensated InGaAs material doped with N, to provide the photo-detector material with needed energy gap of ˜1.34 eV. In both InP and GaAs-based embodiments, the photo-detector dark current should be sufficiently low to allow room temperature operation and the material quality of epitaxial layers is therefore an important consideration. In both cases, one can expect a nearly complete collection of light that reaches the detector layers in each slab.

Those skilled in the art will recognize that owing to the random nature of scintillating radiation approximately 50% of the scintillating light intensity will go to one surface of the slab and 50% to the other. In order to optimize the light collection efficiency detector layers can be deposited on both sides of the slab. In the preferred embodiment, however, detector layers are deposited on one side only, the other side being coated with a light reflecting mirror structure (not shown) to reflect light at the surface. Such mirror structures are well-known to those skilled in the art; exemplarily, they can be made of a thin metal film, such as Al, or thin dielectric/metal layers, such as SiO₂/Al, of about 0.1 μm combined thickness.

The 2μ-thick undoped InGaAsP sensitive layer grown on n+InP wafer is followed by a ˜0.1 μm-thin p+InP contact layer. The contact lines 23 and 24 in FIG. 2a contact respective p+ and n+InP sides of the photo-detector structure. The reverse bias voltage is applied between p+ and n+ contact lines 23 and 24 (minus on the p+ lines) to deplete all photo-sensitive layers 20 in the device.

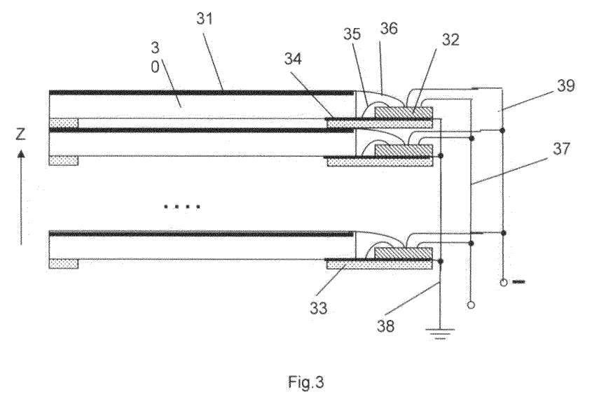

FIG. 3 shows another detector embodiment, according to the present invention, where each slab represents a sub-detector (30) and is endowed with an individual photo-detector 31. In the preferred embodiment it is also endowed with a Si chip 32 attached to the support plate 33. Bottom electrodes 34 on the support plates are attached to the n+ InP slab and connected to the ground in all the sub-detectors. The registered electrical signals from the sub-detectors are then amplified and converted from analog to digital form to minimize the electronic noise. Leads 35 and 36 connect the photo-detector 30 with its Si chip 32, while the line 37 delivers the electronically processed digital signals to the signal analyzing system outside of the detector. Line 38 connects the back of each slab to the ground.

This embodiment enables one to trace the one-dimensional (z-coordinate) dependence of the scintillating response on the depth within the stack. This design offers the valuable possibility to measure the depth profile of radiation penetration and thus also estimate the incident radiation energy. The resolution of this method depends on the wafer thickness: smaller thickness of each sub-detector results in more precise energy measurement.

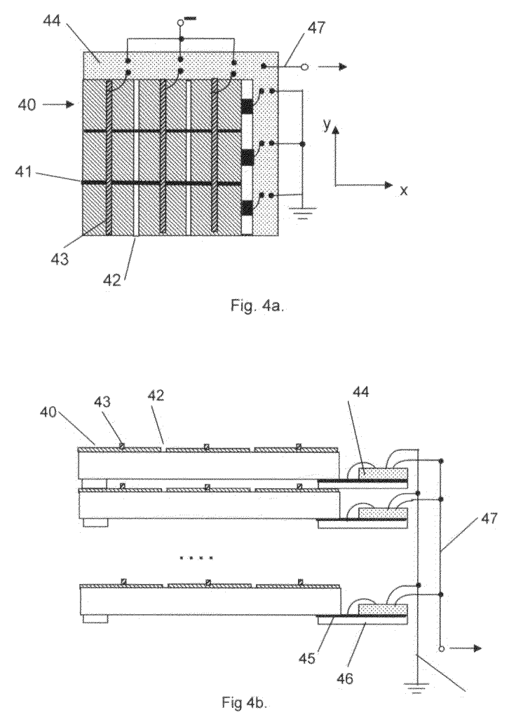

FIG. 4 illustrates still another detector embodiment, with the photo-detector area structured into a two-dimensional pixel array in every wafer. Nine pixels and Si chip per every wafer are shown in FIG. 4a to exemplify the design. Each wafer is cut in x direction into three horizontal (row) stripes 40 electrically isolated from each other, as indicated by the separation lines 41. In the vertical, y, direction of the wafer surface, the top photo-detector structure is etched into three vertical stripes (columns), as indicated by separation lines 42, to form nine electrically isolated pixels of the p-i-n layer. Vertical metal lines 43 connect the pixels in each column with the top side of the Si chip 44 to electronically process the signals and apply negative bias to the p+ layers. The row stripes are connected with the bottom metal lines 45 to the right-hand side of the same chip 44, which for convenience is illustrated as a single L-shape Si piece. This side of the chip also contains 3 amplifiers, means for signal processing and connections to ground line 46. The details of IC components on the Si chip are not shown.

FIG. 4b shows the side view of the detector. Notches 42 in each p-i-n junction layer indicate etching of this layer into three columns, while 3 pixels in each column are connected with metal lines 43. Only right side of the Si chip 44 is shown. Each chip is attached to its wafer using the support glass plate 46 on top of which three metal lines 45 are deposited to connect the rows 40 to the Si chip 44. Line 47 serves as a signal output from every chip.

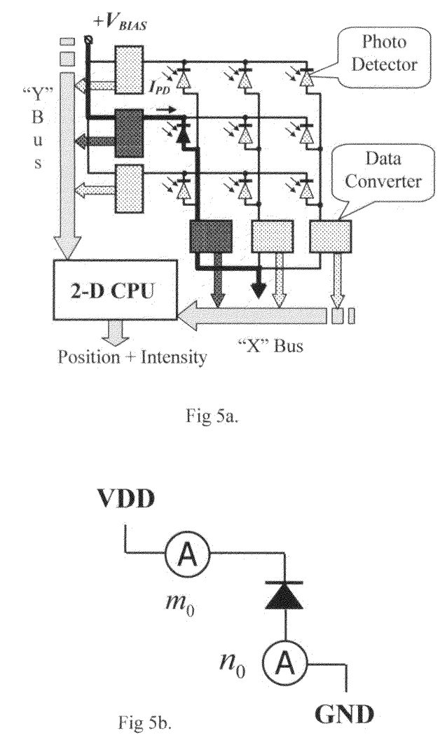

In this design, each pixel circuit formed at an intersection of a single horizontal and a single vertical line comprises two amplifiers. This architecture is further illustrated in the circuit diagram of FIG. 5.

Every pixel is individually addressed, and signal registration from the electronic chips will identify the signal amplitude, the timing and the location of the ionization event within both the pixel matrix area and the detector depth. Thus, such a design allows 3-dimensional signal registration. Such a 3D detector can perform all the functions of the discussed above non-pixellated versions shown in FIGS. 2 and 3. The advantage of the 3D detector for these functions is its low detector-diode capacitance, which is only the p-i-n junction capacitance of a single pixel.

Finally, the same pixellated structure can be made when every wafer, shown in FIG. 4, is cut into three stripes both in horizontal and vertical direction, and then separate pixels are connected vertically (columns) and horizontally (rows) the same way as they are connected in FIG. 4. In this case, there is no need for the pixel etching step to isolate pixels in each row, and every pixel can be placed into a separate holder.

FIG. 5a shows the preferred circuit architecture for the pixellated detector. Each pixel within a single slab is uniquely identified by the two amplifiers that carry the electrical current generated by a given interaction event. The firing pixel and the two associated amplifiers are further illustrated in FIG. 5b which shows the complete circuit diagram for one pixel, from the high applied voltage (VDD) to the ground (GND). It is notable that the disclosed architecture requires only n+m amplifier circuits for n×m pixels in the slab. For k slabs the total number of amplifiers thus required is (n+m)×k. The further advantage of this design is that it eliminates the delivery of high-speed analog signals (of nanosecond duration) off the wafer.

An important advantage of a 3D pixellated radiation detector is that it offers the valuable possibility for data analysis based on simultaneous signal registration by several pixels in the stack. This enables a direct measurement of the incident particle energy, said measurement being complementary to the conventional statistical spectroscopy and free from complications associated with Compton escape processes. This goes to the heart of the contemporary homeland security needs, where accurate spectral characterization of detected gamma radiation is of the essence to avoid “false alarms”. The proposed technology offers unprecedented fidelity in isotope discrimination.

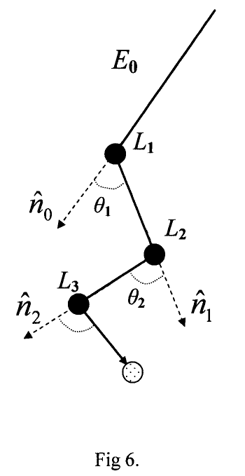

FIG. 6 illustrates a cluster of first three interactions with a gamma quantum of energy E₀ incident in the direction characterized by a unit vector \hat{n}₀ and recorded by the inventive detector. Neither the energy E₀ nor the direction \hat{n}₀ are known and both are of great interest for applications of the radiation detector. The measured data include the energies L₁, L₂, and L₃, deposited at the pixels 1, 2, and 3, respectively, and the 3D coordinates of said pixels. The excellent time resolution of the inventive detector allows one to separate out events triggered by different gamma quanta said events typically being separated in time by a much larger amount than said temporal detector resolution. Kinematic equations describing the interaction between gamma radiation and the material electrons are given by

cos θᵢ=1+Eᵢ₋₁⁻¹−Eᵢ⁻¹ (1a)

Lᵢ=Eᵢ₋₁−Eᵢ (1b)

where Eᵢ₋₁ and Eᵢ are, respectively, the gamma-particle energies before and after the i-th interaction that deposits the energy Lᵢ in the semiconductor. All energies in equation (1) above and equation (2) below are measured in the units of electron rest mass mₑ≈511 KeV. The angle θᵢ is the angle of scattering in the i-th interaction, illustrated in FIG. 6 for i=1 and 2. With the three interactions recorded as shown, one determines the angle θ₂ between the directions \hat{n}₁ and \hat{n}₂ that are known in terms of the 3D coordinates of the three firing pixels. The system of equations (1) then yields the incident gamma quantum energy in the form

$${E}_{0} = {L}_{1} + \frac{{L}_{2}}{2} + \frac{1}{2} ( {L}_{2}^{2} + \frac{4 {L}_{2}}{1 - cos {θ}_{2}} ) \qquad ( 2 )$$

Similarly, the angle θ₁ is determined in terms of L₁, L₂ and θ₂. The knowledge of θ₁ does not yet determine the direction \hat{n}₀ of the incident quantum, which is placed on the cone of angle θ₁ about the known direction \hat{n}₁. Intersections of such cones for two or more incident gamma quanta coming from the same point source, uniquely determines the direction to the source.

The described method of analysis based on equations (1), often referred in the literature as “Compton telescope”, is well-known, see for example, S. E. Boggs and P. Jean, “Event reconstruction in high resolution Compton telescopes”, Astron. Astrophys. Suppl. Ser. 145, 311{321 (2000). It is usually implemented by using an assembly of discrete Ge or Si diode detectors. A large number of such detectors is necessary, for otherwise the events where three detectors fire at the same time would be extremely rare. The large number of discrete detectors leads to a bulky size and considerable cost of such detector assemblies. An advantage of the inventive integrated detector is its relatively small size and low cost combined with the possibility of a very high density of pixels that guarantees a high rate of three-pixel count. Also the high speed of response of the inventive detector enables temporal separation of different incoming particles even when their rate of incidence is itself high. When fully optimized, the inventive detector is expected to distinguish between quanta arriving only 10 nanoseconds apart.

A practical use of the Compton telescope analysis method requires that for a given incident particle or gamma quantum the order of interactions is correctly identified as first, second and third. It should be noted that all three (and possibly more than three) interactions occur essentially at the same time, since the inventive detector cannot resolve them in time, which would require picosecond resolution. No known at this time detection principle can be deployed to order the interaction according to their time of occurrence. However, those skilled in the art know that interactions can be ordered with a reasonable confidence according to their intensity and the cluster geometry. This ordering is enabled by the directionality and the energy-transfer of Compton scattering, as embodied in the well-known Klein-Nishina formula, describing the anisotropic scattering cross-section, σ(θᵢ), viz.

$$σ ( {θ}_{i} ) = {{σ}_{0} ( \frac{{E}_{i}}{{E}_{i - 1}} )}^{2} ( \frac{{E}_{i}}{{E}_{i - 1}} + \frac{{E}_{i - 1}}{{E}_{i}} - {sin}^{2} ( {θ}_{i} ) ) \qquad ( 3 )$$

The ordering procedure is often referred to as tracking algorithm or event reconstruction. Current tracking algorithms claim up to 70% success in correctly ordering events produced by a 1 MeV photon.

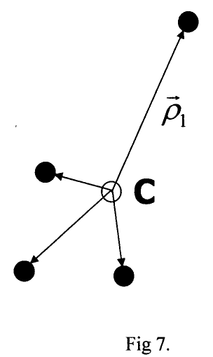

The anisotropy of the Compton scattering cross-section can also be employed for a different type of analysis that is advantageous for the determination of direction to source and is enabled by the inventive detector. The new analysis method is illustrated in FIG. 7. It only requires the correct identification of the first interaction, which can be identified with the probability of over 80% by energy ordering and by analyzing the cluster geometry, as has been verified by our preliminary Monte Carlo simulations. The procedure works as follows. For each cluster comprising n points, i.e. for each incoming particle, we first determine the geometrical center of the cluster,

$$\vec{C} = \frac{1}{n} {\sum }_{i = 1}^{n} {\vec{r}}_{i}$$

and then draw a vector \vec{ρ}₁ from \vec{C} to the first interaction.

Because of the directional (axial) symmetry of Compton interaction, the average vector [symbol] \vec{ρ}₁ [symbol] averaged over a statistical ensemble comprising multiple realizations of the cluster, corresponding to different incoming photons, tends to a mean value \vec{ρ} which is parallel to \hat{n}₀ and points in the direction to the source. It is easy to write an expression for the value of [symbol] \vec{ρ}₁ [symbol] averaged over a sub-ensemble of Nₙ clusters, that comprise exactly n interactions,

$${〈 {\vec{ρ}}_{1} 〉}_{n} ≡ \frac{1}{{N}_{n}} {\sum }_{j = 1}^{{N}_{n}} {\vec{ρ}}_{1}^{( j )} = ( {np}_{n} - 1 ) \vec{ρ} + \frac{\vec{δ}}{\sqrt{{N}_{n}}} \qquad ( 4 )$$

where \vec{δ} is an error vector normal to \vec{ρ} and pₙ is the probability of correctly guessing the first interaction in a cluster of n points. So long as the guess is much better than random, pₙ>1/n, the procedure converges rapidly, as has been verified by a Monte Carlo simulation. We are free to analyze any sub-ensemble separately, the full ensemble comprising N=N₁+N₂+ . . . +Nₙ sub-ensembles. The final [symbol] \vec{ρ}₁ [symbol] is a statistical average of the values [symbol] \vec{ρ}₁ [symbol] obtained for the partial sub-ensembles.

Both the polar and azimuth angles (θ,φ) of \hat{n}₀ are determined. As we examine more and more incoming γ particles, the precision improves. For N=1,000 we find \hat{n}₀ to within about 2°, for N=10⁴ to about 0.5°. The relative error associated with the finite pixel size d goes as (d/D)², where D=D(E₀) is the typical linear dimension of a cluster. For E₀=660 keV and d≦1 mm, this error does not affect the above estimates of the precision. Neither does the error associated with the Doppler effect, which only makes a small contribution to the \vec{δ} in Eq. (4).

We claim:

1. Semiconductor scintillator for detection of high-energy radiation, comprising a stack of direct-gap semiconductor slabs, each of said slabs provided with integrated photosensitive layers capable of detecting the scintillation signal resulting from an event of absorption of high-energy radiation quantum in the body of the slab, said photosensitive layers being epitaxially grown on at least one of the flat surfaces of the slab using lattice-matched heterostructure layers, and further comprising means for electronic processing of the detected signal and means for delivering the information about said absorption event to a recording unit.

2. Semiconductor scintillator as in claim 1, wherein the body of each said slab is degenerately doped with shallow donors so as to maximize the delivery of said optical signal to the surface of said slab and reduce the radiative recombination time.

3. Semiconductor scintillator as in claim 1, wherein each said slab represents a semiconductor wafer of thickness shorter than the absorption length of high-energy radiation.

4. Semiconductor scintillator as in claim 1, wherein said are epitaxially grown lattice-matched heterostructure layers form a PIN photo-diode.

5. Semiconductor scintillator as in claim 1, wherein the body of said slabs are made from InP.

6. Semiconductor scintillator as in claim 1, wherein the body of said slabs are made from GaAs.

7. Semiconductor scintillator as in claim 5, wherein said epitaxially grown lattice-matched heterostructure layers comprise a quaternary InGaAsP photo-sensitive layer.

8. Semiconductor scintillator as in claim 7, wherein said quaternary InGaAsP photo-sensitive layer is sandwiched between p and n contact layers made of appropriately doped InP.

9. Semiconductor scintillator as in claim 6, wherein said epitaxially grown lattice-matched heterostructure layers comprise a stress-compensated dilute-nitride composition InGaAs/N as a photo-sensitive layer.

10. Semiconductor scintillator as in claim 9, wherein said dilute-nitride composition InGaAs/N layer is sandwiched between p and n contact layers made of appropriately doped GaAs.

11. Semiconductor scintillator as in claim 1, wherein said photosensitive layers in said slabs are connected in parallel to each other, providing an integrated electrical signal from the scintillator to an externally located amplifier.

12. Semiconductor scintillator as in claim 1, wherein said photosensitive layers are laterally pixellated forming a two-dimensional array in each of said slabs.

13. Semiconductor scintillator as in claim 12, further supplied with an electrical circuit that addresses each pixel in the two-dimensional array, amplifies the output signal from that pixel which is active in a particular absorption event and converts said signal to a digital form preserving the information about the position of said active pixel in said two-dimensional array.

14. Semiconductor scintillator as in claim 13, wherein the stack of said two-dimensional arrays is electrically addressed as a three-dimensional array, characterized in that the two-dimensional position of said active pixel is further supplemented with the information about the position of said two-dimensional array in said stack.

15. Semiconductor scintillator as in claim 13, further supplied with an electrical clock circuit that preserves the information about the time of the pixel activity, said time determined with an accuracy sufficient to distinguish the pixel activity resulting from absorption events corresponding to different high-energy radiation quanta.

16. Semiconductor scintillator as in claim 15, in which the digitized signal from pixels activated by an absorption event corresponding to a single high-energy radiation quantum is analyzed with respect to the three-dimensional position of active pixels and the signal magnitude in each active pixel to obtain information about the energy of said high-radiation quantum and the direction of its incidence on the scintillator.
